(19) United States
(12) Patent Application Publication
(10) Pub. No.: US 2005/0038277 A1
(43) Pub. Date: Feb. 17, 2005

(54) Use of a catalyst system based on a platinum group metal and a heterocyclic organic compound for hydrosilylation of unsaturated reagents

(75) Inventors: Delphine Blanc-Magnard, Lyon (FR); Sebastien Sterin, Lyon (FR)

Correspondence Address: BURNS DOANE SWECKER & MATHIS L L P, POST OFFICE BOX 1404, ALEXANDRIA, VA, 22313-1404, US

(73) Assignee: RHODIA CHIMIE, Boulogne Billancourt Cedx (FR)

(21) Appl. No.: 10/493,846

(22) PCT Filed: Oct. 29, 2002
(86) PCT No.: PCT/FR02/03716

(30) Foreign Application Priority Data
Oct. 30, 2001 (FR) 01/14040

(51) Int. Cl. C07F 7/04; C07F 15/00; C08G 63/48

(52) U.S. Cl. 556/479; 549/206; 525/29

(57) ABSTRACT

The present invention relates to the use as catalyst for the hydrosilylation of at least one unsaturated reactant (A) with at least one silicone monomer, oligomer and/or polymer (B) having per molecule at least one reactive ≡SiH unit, in the presence of a homogeneous catalyst system comprising (i) a platinum group metal, preferably a complexed metal, and (ii) a heterocyclic organic compound of lactone type.

The present invention pertains to the field of the catalysis of hydrosilylation reactions in which reactants possessing at least one unsaturated bond are contacted with monomers, oligomers and/or polymers of polyorganosiloxane type which possess at least one ≡SiH unit in the presence of a new catalyst system based on a platinum group metal and a heterocyclic organic compound.

It is known in the prior art to prepare polyorganosiloxane compounds by reacting a hydropolyorganosiloxane with a reactant carrying an unsaturated bond in the presence of a catalyst; this reaction is commonly termed hydrosilylation. In general the catalyst is platinum-based and may be present in various forms: on a support, in pure phase (liquid or solid) or in a solvent.

More specifically the invention aims to provide for the use of new catalyst systems based on a platinum group metal and a heterocyclic organic compound for hydrosilylating, in particular, unsaturated reactants and polyorganosiloxanes carrying at least one ≡SiH unit, this catalyst system substantially accelerating the said reaction without loss of selectivity and at the same time inhibiting gelling phenomena.

These objectives are achieved by means of catalyst systems based on a platinum group metal and a judiciously selected heterocyclic compound.

The present invention accordingly first provides for the use as catalyst, especially heat-activatable catalyst, for the hydrosilylation of at least one unsaturated reactant (A) with at least one silicone monomer, oligomer and/or polymer (B) having per molecule at least one reactive ≡SiH unit, in the presence of a homogeneous catalyst system-comprising (i) a metal, preferably a complexed metal, selected from the group consisting of rhodium, ruthenium, platinum, palladium, iridium and/or nickel and (ii) a heterocyclic organic compound of lactone type.

These catalyst systems are particularly advantageous in terms of reactivity insofar as they are active at low concentrations and, advantageously, necessitate only small quantities of energy to effect the hydrosilylation.

The catalyst systems claimed therefore prove particularly advantageous in terms of profitability and cost for industrial processes.

Particular preference is given according to the invention to catalyst systems whose heterocyclic organic compound contains at least 5 atoms within the ring and is selected from those of formula (1) below: 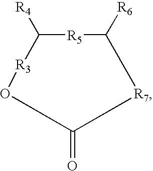
in which:
the groups R₃, R₅ and R₇, which are identical or different, represent (i) a free valency, (ii) a saturated or unsaturated, linear or branched alkyl radical, which may be substituted, or (iii) a saturated or unsaturated, linear or branched alkylene radical, which may be substituted;
the groups R₄ and R₆, which are identical or different, represent (i) a hydrogen atom, (ii) a saturated or unsaturated, linear or branched alkyl radical, which may be substituted, or (iii) a saturated or unsaturated, linear or branched alkylene radical, which may be substituted, or (iv) form a linear or branched, saturated or unsaturated hydrocarbon ring, which may be substituted.

By way of examples the heterocyclic lactone compounds may be selected from those of the formulae below:

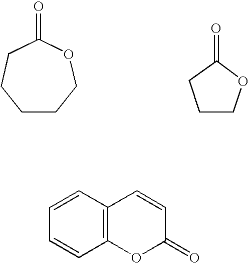

Other compounds are described in “Synthesis of lactones and lactams” by Michael A Ogliaruso and James F Wolfe [©1993, John Wiley & Sons].

In general the molar ratio of the heterocyclic compound to the platinum group metal is between 10 and 10 000, preferably between 100 and 1000. Moreover, the metal within the catalyst system is preferably platinum, in particular in zero oxidation state. By way of examples, mention may be made in particular of the complexed platinums of Karstedt type.

For activating the catalyst system according to the invention it is possible to use any type of heating source.

In the context of the present invention the term unsaturated reactant (A) signifies that the compound contains at least one unsaturated bond and is selected from the group consisting of:
(A1) substituted or unsubstituted unsaturated organic compounds,
and/or (A2) silicone compounds comprising substituted or unsubstituted unsaturated organic compounds.

Preferably the unsaturated reactants (A1) are selected from the following:
substituted or unsubstituted, linear or branched alkenes containing 2 to 30 carbon atoms,
and substituted or unsubstituted, linear or branched alkynes containing 2 to 30 carbon atoms.

The alkenes may be, for example, 1-hexene, 1,5-hexadiene, 1-octene and/or 1-dodecene. The alkynes may be, for example, 1-hexyne and/or 1-octyne.

The silicone reactants (A2) are preferably selected from polyorganosiloxanes containing:
similar or different units of formula (1):

$${W}_{d}^{′} {Y}_{e} {SiO}_{\frac{4 - ( d + e )}{2}} \qquad ( 1 )$$

in which:
the radicals W′, which are similar and/or different, represent:
a linear or branched alkyl radical containing 1 to 18 carbon atoms which is optionally substituted by at least one halogen, preferably fluorine, the alkyl radicals being preferably methyl, ethyl, propyl, octyl and 3,3,3-trifluoropropyl,
a cycloalkyl radical containing between 5 and 8 ring carbon atoms which is optionally substituted by at least one halogen, preferably fluorine, an aryl radical containing between 6 and 12 carbon atoms, which can be substituted optionally on the aryl moiety by halogens or by alkyls and/or alkoxies containing 1 to 3 carbon atoms, preferably phenyl or dichlorophenyl,
an arylalkyl radical having an alkyl moiety containing between 5 and 14 carbon atoms and an aryl moiety containing between 6 and 12 carbon atoms, which is substituted optionally on the aryl moiety by halogens or by alkyls and/or alkoxies containing 1 to 3 carbon atoms,
the symbols Y, which are similar or different, represent a linear or branched C₂-C₁₂ alkenyl residue having at least one ethylenic unsaturation at the chain end and optionally at least one heteroatom;
e is 1 or 2, d is 0, 1 or 2, with the sum (d+e) having a value of between 1 and 3;
and optionally other units of average formula (2):

$${W}_{c}^{′} {SiO}_{\frac{4 -- c}{2}} \qquad ( 2 )$$

in which W′ is as defined above and c has a value of between 0 and 3.

The polyorganosiloxane (A2) may be formed solely of units of formula (1) or may additionally contain units of formula (2).

Advantageously the radicals Y are selected from the following list: vinyl, propenyl, 3-butenyl, 5-hexenyl, 9-decenyl, 10-undecenyl, 5,9-decadienyl and 6,11-dodecadienyl.

These polyorganosiloxanes may have a linear (branched or otherwise), cyclic or network structure. Their degree of polymerization is preferably between 2 and 5000.

When they are linear polymers they are composed essentially of “D” units W′₂SiO_{2/2}, W′YSiO_{2/2} and Y₂SiO_{2/2}, and “M” units W′₃SiO_{1/2}, W′Y₂SiO_{1/2} and W′₂YSiO_{1/2}.

Examples of terminal “M” units include the groups trimethylsiloxy, dimethylphenylsiloxy, dimethylvinylsiloxy, dimethylhexenylsiloxy, dimethylethoxysiloxy and dimethylethyltriethoxysiloxy.

Examples of “D” units include the groups dimethylsiloxy, methylphenylsiloxy, methylvinylsiloxy, methylbutenylsiloxy, methylhexenylsiloxy, methyldecenylsiloxy, methyldecadienylsiloxy, methyl-3-hydropropylsiloxy, methylbutoxysiloxy, methyl-β-trimethoxysilylethylsiloxy and methyl-p-triethoxy-silylethylsiloxy.

The said linear polyorganosiloxanes (A2) may be oils with a dynamic viscosity at 25° C. of the order of 1 to 100 000 mPa.s at 25° C., generally of the order of 10 to 5000 mpa.s at 25° C., or gums having a molecular mass of the order of 1 000 000.

When they are cyclic polyorganosiloxanes they are composed of “D” units W₂SiO_{2/2}, Y₂SiO_{2/2} and WYSiO_{2/2}, which may be of the dialkylsiloxy, alkylarylsiloxy, alkylvinylsiloxy or alkylsiloxy type; examples of such units have already been given above. The said cyclic polyorganosiloxanes (A2) have a viscosity of the order of 1 to 5000 mpa.s.

Preferably the polyorganosiloxane derivatives (B) are selected from polyorganohydrosiloxanes containing:
units of formula (3) as follows:

$${H}_{a} {W}_{b} {SiO}_{\frac{4 - ( a + b )}{2}} \qquad ( 3 )$$

in which:
the radicals W, which are similar and/or different, are identical in definition to W′,
and a is 1 or 2, b is 0, 1 or 2, with the sum (a+b) having a value of between 1 and 3,
and optionally other units of average formula (2):

$${W}_{c} {SiO}_{\frac{4 - c}{2}} \qquad ( 2 )$$

in which W is as defined above and c has a value of between 0 and 3.

The polyorganosiloxane (B) may be formed solely of units of formula (3) or may additionally contain units of formula (2). It may have a linear structure, branched or otherwise, or a cyclic or network structure. The degree of polymerization is greater than or equal to 2. More generally it is less than 5000.

Examples of units of formula (3) are:
H(CH₃)₂SiO_{2/2}, HCH₃SiO₂₁₂, H(C₆H₅)SiO_{2/2}.

When the polymers are linear polymers they are composed essentially of “D” units W₂SiO_{2/2} and WHSiO_{2/2} and “M” units W₃SiO_{1/2} and W₂HSiO_{1/2}.

These linear polyorganosiloxanes may be oils with a dynamic viscosity at 25° C. of the order of 1 to 100 000 mpa.s at 25° C., generally of the order of 10 to 5000 mpa.s at 25° C., or gums having a molecular mass of the order of 1 000 000.

When they are cyclic polyorganosiloxanes they are composed of “D” units W₂SiO_{2/2} and WHSiO_{2/2}, which may be of the dialkylsiloxy or alkylarylsiloxy type. They have a viscosity of the order of 1 to 5000 mPa.s.

The dynamic viscosity at 25° C. of all of the polymers under consideration in the present specification can be measured using a Brookfield viscosimeter in accordance with standard AFNOR NFT 76 102 from February 1972.

Examples of polyorganosiloxanes (B) include dimethylpolysiloxanes having hydrodimethylsilyl ends, dimethylhydromethylpolysiloxanes having trimethylsilyl ends, dimethylhydromethylpolysiloxanes having hydrodimethylsilyl ends, hydromethylpolysiloxanes having trimethylsilyl ends, and cyclic hydromethyl-polysiloxanes.

Particular preference as derivatives (B) is given to oligomers and polymers corresponding to the general formula (4): 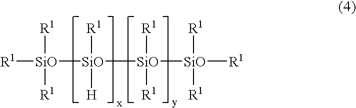
in which:
x and y are each an integer varying between 0 and 200,
R₁ radicals, which are identical or different, represent independently of one another:
a linear or branched alkyl radical containing 1 to 8 carbon atoms which is optionally substituted by at least one halogen, preferably fluorine, the alkyl radicals being preferably methyl, ethyl, propyl, octyl and 3,3,3-trifluoropropyl,
an optionally substituted cycloalkyl radical containing between 5 and 8 ring carbon atoms,
an optionally substituted aryl radical containing between 6 and 12 carbon atoms,
an aralkyl radical having an alkyl moiety containing between 5 and 14 carbon atoms and an aryl moiety containing between 6 and 12 carbon atoms, which is optionally substituted on the aryl moiety.

Particularly suitable for the invention as silicone derivative (B) are the following compounds: 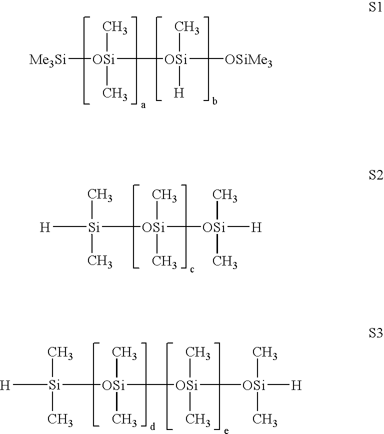
with a, b, c, d and e representing a number varying from:
in the polymer of formula S1:
   0≦a≦150, preferably 0≦a≦100, and more particularly 0≦a≦20, and
   1≦b≦55, preferably 10≦b≦55, and more particularly 30≦b≦55,
in the polymer of formula S2: 0≦c≦15,
in the polymer of formula S3: 5≦d≦200, preferably 20≦d≦50, and 2≦e≦50, preferably 10≦e≦30.

According to one particularly preferred embodiment the polyorganosiloxane polymers, oligomers and monomers (B) containing reactive SiH unit include from 1 to 50 active SiH units per molecule.

In the context of the invention the amount of silicone (B) and of reactant (A) within the reaction mixture is selected such that the ratio of the number of S1H-units in the silicone (B) to the number of unsaturated bonds in the reactant (A) is between 0.01 and 100, preferably between 0.1 and 10.

A second aspect of the present invention is directed to a catalyst system which allows the reaction to be accelerated without loss of selectivity and at the same time inhibits gelling phenomena. This homogeneous catalyst system comprises (i) a metal, preferably a complexed metal, selected from the group consisting of cobalt, rhodium, ruthenium, platinum and nickel, and (ii) a heterocyclic organic compound of lactone type.

This catalyst system according to the invention may be employed in accordance with a variety of versions; it may be prepared before use or prepared within the reaction mixture. In particular it is possible to implement a regime in which all of the reactants and the catalyst system are mixed in the reaction mixture (batch type).

In the course of its experiments the Applicant has developed an advantageous process for preparing functional silicone oils in accord with this regime. This hydrosilylation process of at least one silicone monomer, oligomer and/or polymer (B) and unsaturated reactant (A) comprises the following steps:
(a) introducing the unsaturated reactant (A) into the reaction mixture;
(b) introducing into the reaction mixture the catalyst system comprising the heterocyclic compound and the platinum group metal, the metal content being from 5 to 5000 ppm, preferably from 10 to 100 ppm, relative to the total mass of the reactants, and the molar ratio of the heterocyclic compound to the platinum group metal being between 10 and 10 000, preferably between 100 and 1000;
(c) heating the mixture to a temperature of between 20° C. and 200° C., and preferably between 50° C. and 160° C.;
(d) subsequently introducing silicone (B) over a period of between 0 and 24 hours, preferably between 2.5 and 5 hours, the ratio of the number of SiH units to the number of hydrosilylatable units being between 0.1 and 10.

According to one preferred embodiment-of this process, step (a) is carried out before step (b). More particularly the heterocyclic compound may be mixed with the reactant (A) before the addition of the platinum group metal.

Where silicone networks are prepared from silicones of type (A2) and silicones of type (B), the process employed preferably comprises the following steps:
(a) introducing constituents of the catalyst composition into the reaction mixture of the silicone (A2),
(b) introducing the silicone (B) and a crosslinking retarder, and
(c) optionally heating the mixture to a temperature of between 20° C. and 200° C., and preferably between 50° C. and 160° C.

The hydrosilylation processes in the context of the invention may be carried out in bulk, which means that the reaction between the silicone (B) and the unsaturated reactant (A) takes place in the absence of solvent. However, numerous solvents, such as toluene, xylene, octamethyltetrasiloxane, cyclohexane or hexane, can be used. Where appropriate the reaction product obtained is lastly devolatilized.

### EXAMPLES

The examples which follow demonstrate the advantage of the invention both for synthesis reactions of functional silicone oils and for reactions which allow silicone polyaddition networks to be obtained. The addition of a moderate amount of one of the compounds claimed above makes it possible to accelerate the hydrosilylation reaction markedly.

The platinum catalyst used is a complex of platinum(0) in solution at 10% by weight of platinum in α,ω-divinyl silicone oils. The platinum concentration is calculated relative to the total mass of the stoichiometric alkene+SiH-silicone oil mixture.

I. Synthesis of Epoxy Silicone Oils

Examples 1 to 4 demonstrate the advantage of using a lactone catalyst system according to the invention in hydrosilylation reactions of monomers of 1,2-epoxy-4-vinylcyclohexane type.

As a comparative example syntheses were carried out in the presence of a linear ester (comparative example 1) and in the absence of any organic compound (comparative examples 2 and 3).

In these examples the amount of organic compound added is expressed in weight, calculated relative to the VCMX introduced (i.e. 1000 ppm signifies 1 g per kg of VCMX).

I.A. Procedure for Examples 1 to 3 and Comparative Examples 1 and 2

21.48 g (173 mmol) of VCMX and the organic compound (see table 1 below) are charged to a 100 ml reactor.

The reaction mixture is heated to 70° C. with stirring. 5.5 μl (10 ppm) of a solution of Karstedt catalyst containing 10% of platinum are added to the reactor and 35 g (157.3 mmol) of heptamethyl-hydrotrisiloxane are subsequently run in dropwise onto the VCMX.

At the end of the addition, the degree of conversion of the SiH units is measured.

TABLE 1

| | | Amount | DC_{SiH} at end |
|---|---|---|---|
| | Organic | added | of addition |
| | compound | (ppm) | (%) |
| Example 1 | 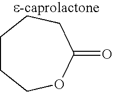 | 1000 | 99.8 |
| Example 2 | 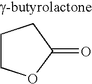 | 1000 | 98.4 |
| Example 3 | 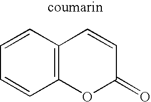 | 1280 | 97.5 |
| Comparative example 1 | 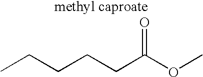 | 1140 | 92.0 |
| Comparative | / | / | 93.5 |
| example 2 | | | |

I.B. Procedure Followed for Example 4 and Comparative Example 3
6.5 g (52.3 mmol) of VCMX and the organic compound (see table 2 below) are charged to a 100 ml reactor. The reaction mixture is heated to 70° C. with stirring.
5.1 μl (10 ppm) of a solution of Karstedt catalyst containing 10% of platinum are added to the reactor,
and then 45 g (47.57 mmol) of polyorganohydro-siloxane in which the number of milliequivalents of ≡SiH function is 106 per 100 g, and which has the formula below: 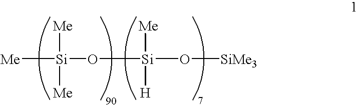
   are added dropwise.

The time required to reach total conversion of the SiH units is measured. The start of the time is taken to be the beginning of the addition of the SiH fluid.

TABLE 2

| | | Amount | Total |
|---|---|---|---|
| | Organic | added | conversion |
| | compound | (ppm) | of SiH |
| Example 4 | ε-caprolactone | 1000 | 3 hours |
| Comparative | / | / | 5 hours |
| example 3 | | | |

II. Preparation of Silicone Networks: Hydrosilylation of α,ω-Divinyl Oils with Heptamethylhydrotrisiloxane (Polyaddition)

The reactions below are performed in the presence of a retarder of ynol type. These examples show the advantage of using a catalyst system according to the invention for improving hydrosilylation rates.

The catalyst system according to the invention makes it possible both, in particular, to obtain significantly more rapid kinetics (table 3) and to retain very good activity of the platinum, even when the retarder/Pt ratio goes up (table 4).

II.A.Procedure for Example 5 and Comparative Example 4

70 grams (15.82 meq of Vi units) of α,ω-divinyl-tetramethyl(dimethylpolysiloxane) oil, 4.05 grams (18.19 meq of Si—H units) of heptamethylhydrotrisiloxane oil, 72.9 milligrams (0.587 mmol) of ethynylcyclohexanol and ε-caprolactone (see table below) are charged to a 125 ml reactor.

36 μl (49 ppm) of a solution of Karstedt catalyst containing 10% of platinum are subsequently added all at once and the reaction mixture is stirred at ambient temperature until there is total conversion of all the SiH groups.

The kinetics are monitored starting from the introduction of the catalyst (t=0 min) by gasometry: see table 3.

II.B. Procedure for Example 6 and Comparative Example 5

70 grams (15.82 meq of Vi units) of α,ω-divinyl-tetramethyl(dimethylpolysiloxane) oil, 4.05 grams (18.19 meq of Si—H units) of heptamethylhydrotrisiloxane oil, 92.7 milligrams (0.747 mmol) of ethynylcyclohexanol and α-caprolactone (see table below) are charged to a 125 ml reactor.

36 μl (49 ppm) of a solution of Karstedt catalyst containing 10% of platinum are subsequently added all at once and the reaction mixture is stirred at ambient temperature until there is total conversion of all the SiH groups.

The kinetics are monitored starting from the introduction of the catalyst (t=0 min) by gasometry: see table 4.

TABLE 3

| | Example 5 | Comparative |
|---|---|---|
| | ECH/Pt = 31 | example 4 |
| | 426 mg | ECH/Pt = 31 |
| ε-caprolactone | (3.73 mmol) | / |
| DC_{SiH} (%) | 20 min: 2% | 20 min: 1% |
| | 40 min: 6% | 40 min: 1% |
| | 55 min: 15% | 60 min: 7% |
| | 70 min: 32% | 80 min: 15% |
| | 81 min: 95% | 100 min: 29% |
| | 95 min: 98% | 120 min: 85% |
| | 140 min: 100% | 140 min: 94% |
| | | 170 min: 97% |
| | | 240 min: 100% |

TABLE 4

| | Example 6 | Comparative |
|---|---|---|
| | ECH/Pt = 40 | example 5 |
| | 426 mg | ECH/Pt = 40 |
| ε-caprolactone | (3.73 mmol) | / |
| DC_{SiH} (%) | 23 min: 2% | 13 min: 2% |
| | 43 min: 3% | 50 min: 2% |
| | 60 min: 7% | 69 min: 4% |
| | 75 min: 15% | 90 min: 9% |
| | 90 min: 29% | 105 min: 14% |
| | 104 min: 61% | 120 min: 22% |
| | 113 min: 92% | 135 min: 31% |
| | 143 min: 98% | 150 min: 54% |
| | | 165 min: 86% |
| | | 180 min: 93% |
| | | 222 min: 97% |

1. A method for the hydrosilylation of at least one unsaturated reactant (A) with at least one silicone monomer, oligomer and/or polymer (B) having per molecule at least one reactive ≡SiH unit, in the presence of a homogeneous catalyst system comprising (i) a metal selected from the group consisting of rhodium, ruthenium, platinum, palladium, iridium and/or nickel and (ii) a heterocyclic organic compound of lactone type.

2. The method according to claim 1, wherein the heterocyclic organic compound of lactone type comprises at least 5 atoms within the ring and is selected from those of formula (1) below: 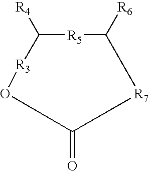
in which:
the groups R₃, R₅ and R₇, which are identical or different, represent (i) a free valency, (ii) a saturated or unsaturated, linear or branched alkyl radical, which may be substituted, or (iii) a saturated or unsaturated, linear or branched alkylene radical, which may be substituted,
the groups R₄ and R₆, which are identical or different, represent (i) a hydrogen atom, (ii) a saturated or unsaturated, linear or branched alkyl radical, which may be substituted, or (iii) a saturated or unsaturated, linear or branched alkylene radical, which may be substituted, or (iv) form a linear or branched, saturated or unsaturated hydrocarbon ring, which may be substituted.

3. The method according to claim 1, wherein the metal of the catalyst system is platinum.

4. The method according to claim 1, wherein the polyorganosiloxane polymers, oligomers and/or monomers (B) containing reactive SiH unit(s) are selected from polyorganohydrosiloxanes comprising:
units of formula (3) as follows:
$${H}_{a} {W}_{b} {SiO}_{\frac{4 - ( a + b )}{2}} \qquad ( 3 )$$
in which:
the radicals W, which are similar and/or different, represent:
a linear or branched alkyl radical comprising 1 to 18 carbon atoms which is optionally substituted by at least one halogen,
a cycloalkyl radical comprising between 5 and 8 ring carbon atoms which is optionally substituted by at least one halogen,
an aryl radical comprising between 6 and 12 carbon atoms, which can be substituted optionally on the aryl moiety by halogens, alkyls and/or alkoxies comprising 1 to 3 carbon atoms,
an arylalkyl radical having an alkyl moiety comprising between 5 and 14 carbon atoms and an aryl moiety comprising between 6 and 12 carbon atoms, which is substituted optionally on the aryl moiety by halogens, alkyls and/or alkoxies comprising 1 to 3 carbon atoms,
and a is 1 or 2, b is 0, 1 or 2, with the sum (a+b) having a value of between 1 and 3,
and optionally other units of average formula (2):
$${W}_{c} {SiO}_{\frac{4 - c}{2}} \qquad ( 2 )$$
in which W is as defined above and c has a value of between 0 and 3.

5. The method according to claim 4, wherein the polyorganohydrosiloxanes (B) correspond to the general formula (4): 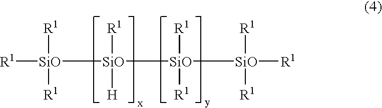
in which:
x and y are each an integer varying between 0 and 200,
R₁, which are identical or different, represent independently of one another:
a linear or branched alkyl radical comprising 1 to 8 carbon atoms which is optionally substituted by at least one halogen,
an optionally substituted cycloalkyl radical comprising between 5 and 8 ring carbon atoms,
an optionally substituted aryl radical comprising between 6 and 12 carbon atoms,
an aralkyl radical having an alkyl moiety comprising between 5 and 14 carbon atoms and an aryl moiety comprising between 6 and 12 carbon atoms, which is optionally substituted on the aryl moiety.

6. The method according to claim 1, wherein the polyorganosiloxane polymers, oligomers and/or monomers (B) are selected from the compounds of formula: 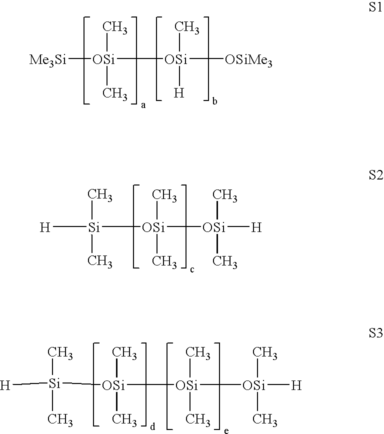
with a, b, c, d and e representing a number varying from:
in the polymer of formula Si: 0≦a≦150,
in the polymer of formula S2: 0≦c≦15,
in the polymer of formula S3: 5≦d≦200.

7. The method according to claim 1, wherein the polyorganosiloxane polymers, oligomers and/or monomers (B) comprising reactive SiH unit in comprise from 1 to 50 active SiH units per molecule.

8. The method according to claim 1, wherein the unsaturated reactant (A) is selected from the group consisting of:
(A1) substituted or unsubstituted unsaturated organic compounds,
and/or (A2) silicone compounds comprising substituted or unsubstituted unsaturated organic compounds.

9. The method according to claim 8, wherein the unsaturated reactant (A1) is selected from at least one compound from the group consisting of:
linear or branched alkenes comprising 2 to 30 carbon atoms, which are substituted or unsubstituted,
and/or linear or branched alkynes comprising 2 to 30 carbon atoms, which are substituted or unsubstituted.

10. The method according to claim 9, wherein the unsaturated reactant (A2) is selected from at least one polyorganosiloxane comprising:
similar or different units of formula (1):
$${W}_{d}^{′} {Y}_{e} {SiO}_{\frac{4 - ( d + e )}{2}} \qquad ( 1 )$$
in which:
the radicals W′, which are similar and/or different, represent:
a linear or branched alkyl radical comprising 1 to 18 carbon atoms which is optionally substituted by at least one halogen,
a cycloalkyl radical comprising between 5 and 8 ring carbon atoms which is optionally substituted by at least one halogen,
an aryl radical comprising between 6 and 12 carbon atoms, which can be substituted optionally on the aryl moiety by halogens, alkyls and/or alkoxies comprising 1 to 3 carbon atoms,
an arylalkyl radical having an alkyl moiety comprising between 5 and 14 carbon atoms and an aryl moiety comprising between 6 and 12 carbon atoms, which is substituted optionally on the aryl moiety by halogens, alkyls and/or alkoxies comprising 1 to 3 carbon atoms,
the symbols Y, which are similar or different, represent a linear or branched C₂-C₁₂ alkenyl residue having at least one ethylenic unsaturation at the chain end and optionally at least one heteroatom;
e is 1 or 2, d is 0, 1 or 2, with the sum (d+e) having a value of between 1 and 3;
and optionally other units of average formula (2):
$${W}_{c}^{′} {SiO}_{\frac{4 -- c}{2}} \qquad ( 2 )$$
in which W′ is as defined above and c has a value of between 0 and 3.
